(19) United States
(12) Patent Application Publication
(10) Pub. No.: US 2009/0017163 A1
(43) Pub. Date: Jan. 15, 2009

(54) Composition comprising bacteria and lecithin

(75) Inventors: Chiara Garbolino, At Vlaardingen (NL); Jan Willem Sanders, At Vlaardingen (NL)

Correspondence Address: UNILEVER PATENT GROUP, 800 SYLVAN AVENUE, AG West S. Wing, ENGLEWOOD CLIFFS, NJ, 07632-3100, US

(73) Assignee: Conopco, Inc. d/b/a Unilever

(21) Appl. No.: 12/218,023

(22) Filed: Jul. 10, 2008

(30) Foreign Application Priority Data
Jul. 13, 2007 (EP) EP07112451

(51) Int. Cl. A23C 9/127

(52) U.S. Cl. 426/61

(57) ABSTRACT

The present invention relates to a composition comprising live food grade bacterium and lecithin wherein the water activity of the composition is at least 0.5 and the amount of fat is between 10 and 80 wt %. It was surprisingly found that lecithin enhances the viability of bacteria in compositions.

Nowadays more and more food products are on the market containing probiotics. Probiotic cultures are intended to assist the body's naturally occurring gut microflora to reestablish the gut microflora balance. Claims are made that probiotics strengthen the immune system.

Although the name probiotica is widely used in the art it is defined as a live microbial food supplement that exerts beneficial effect for the host via improvement of the microbiological balance in the intestine (Ziemer and Gibson, Int. Dairy Journal 8 (1998) 473-479). The amount of live bacteria is thus important.

Probiotic bacteria are widely used in chilled dairy products such as yoghurt. Whilst attempts have been made to produce spreads, such as margarine, which contain probiotics, problems have been encountered with bacterial viability and/or product quality. Since, unlike yoghurt which is purchased and consumed within a relatively short period after manufacture, margarine is stored much longer, sometimes even for many months after sale, while being consumed. The long term survival of probiotics in products with a longer shelf-life is a consideration since the product needs to deliver a sufficient dose of live bacteria at the point of consumption. Consequently, significant losses of viable bacteria over several weeks or months need to be avoided.

EP1732395 discloses a method for incorporating probiotics in a water-in-oil emulsion by adding the probiotic in a hydrophobic medium to an already formed water-in-oil emulsion. The viability of the probiotics was thereby increased.

WO2005/105980 discloses probiotic compositions which enable to maintain effectively physiological activity for a long time comprising a colorant.

WO01/91569 discloses fat-in oil spreads with live bacterial culture and a hydropexic hydrocolloid.

WO2006/12850 discloses a specific bifodobacterial species. A probiotic composition comprising this species with an acceptable excipients is also disclosed. Among the list of suitable excipients lecithin is mentioned.

WO2004/028460 discloses that certain vegetable oil may have an influence on the viability of probiotics. As oil are normally degummed, i.e. removal of phospholipids, there is no suggestion that lecithin may influence the viability.

U.S. Pat. No. 4,713,341 discloses a process for improving activity of acid producing bacteria in dairy media and for providing a buffering effect therein by addition of lecithin. It is directed to the use of starter culture for fermented diary products such as cheese. No probiotic activity is mentioned, and nothing is said about the viability of the bacteria after the fermentation process. In addition the examples are products with low fat (max 2%).

JP 2003 334065 discloses a nucleic acid complex for protecting viable lactic acids in a mixture of gelatinizers and water. The nucleic acid complex is added to an emulsion comprising lecithin and cocoabutter.

Donthidi et al in J. Pharmacy and pharmacology 2006, vol 58 suppl 1, page A34 discloses lactobacillus and bifodobacteria species encapsulated using alginate and lecithin. The obtained products are dry and have a water activity (A_{w}) of less than 0.5. Furthermore the disclosed product does not contain fat and cannot be considered to be a food product.

WO 01/32038 discloses fibrous-liponutrional complexes comprising nutritional substances. One of the nutrional substances may be lactobacilii and or lactospores. The fibrous-liponutrional complexes are dry powders (i.e. A_{w}<0.5) and do not contain fat.

EP 0 339 750 discloses dried forms of leavening barms containing admixtures of lactobacillus and Saccharomyces species. In one example a whole wheat barm paste was made for making a loaf of bread. The barm paste contains soybean oil containing 66% of lecithin. The barm had a water content of 58% and a soybean oil content of 11% on dry matter which amounts to 4.6 wt % of soybean oil.

US 2007/0160589 discloses a probiotic food containing a beneficial amount of dry active probiotic cultures. The food item contains a continuous fat-based coating with a low water activity level, from about 0.2 to about 0.4.

It is therefore an object of the present invention to have a composition comprising bacteria, wherein the survival rate of the bacteria is increased. It is also an object of the invention to have a food product wherein the survival rate of the bacteria is increased. Another object of the invention is to have a composition comprising bacteria that has a long shelf life, e.g. longer than 4 weeks or even up to 2 to 3 months. Yet another object of the present invention is to have a composition comprising bacteria wherein the bacteria are not encapsulated.

It was surprisingly found that a composition comprising lecithin enhances the survival rate of bacteria in the composition.

### DETAILED DESCRIPTION

The present invention concerns a composition comprising live food grade bacterium and lecithin wherein the water activity of the composition is at least 0.5 and the amount of fat is between 10 and 80 wt %.

Lecithin is a mixture of phospholipids. The lecithin may be obtained by degumming the extracted oil of the seeds. The main phospholipids in lecithin are phosphatidyl choline, phosphatidyl inositol, phosphatidyl ethanolamine and phosphatidic acid. They are often abbreviated to PC, PI, PE, and PA respectively. The lipids may contain fatty acids like palmitic acid, stearic acid, oleic acid, linoleic acid and alpha-linoleic acid.

Preferably the lecithin is present in an amount of from 0.01 to 10 wt %. More suitably the composition comprises from 0.05 to 5 wt % lecithin, most suitably from 0.1 to 2 wt %.

Preferred food grade bacteria are Lactobacillus, Bifidobacterium and Streptococcus.

Preferably the food grade bacterium is a probiotic. The probiotic bacteria used according to the present invention may be any conventional probiotic bacteria. It is preferred that the probiotic bacteria are selected from genera Bifidobacterium, Propionibacterium, Enterococcus, Streptococcus, Lactococcus, Bacillus, Pediococcus, Micrococcus, Leuconostoc, Weissella, Oenococcus and Lactobacillus with Lactobacillus, Bifidobacterium and Streptococcus being the most preferred.

Suitable types of probiotic bacteria which may be used include; Bacillus natto, Bifidobacterium adolescentis, B. animalis, B. breve, B. bifidum, B. infantis, B. lactis, B. longum, Enterococcus faecium, Enterococcus faecalis, Escherichia coli, Lactobacillus acidophilus, L. brevis, L. casei, L. delbrueckii, L. fermentum, L. gasseri, L. helveticus, L. johnsonii, L. lactis, L. paracasei, L. plantarum, L. reuteri, L. rhamnosus, L. sakei, L. salivarius, Lactococcus lactis, Lactococcus cremoris, Leuconostoc mesenteroides, Leuconostoc lactis, Pediococcus acidilactici, P. cerevisiae, P. pentosaceus, Propionibacterium freudenreichii, Propionibacterium shermanii and Streptococcus salivarius.

Particular probiotic strains which are suitable according to the present invention are: Lactobacillus casei shirota, Lactobacillus casei immunitas, Lactobacillus casei DN-114 001, Lactobacillus rhamnosus GG (ATCC53103), Lactobacillus reuteri ATCC55730/SD2112, Lactobacillus rhamnosus HN001, Lactobacillus plantarum 299v (DSM9843), Lactobacillus johnsonii La2 (I-1225 CNCM), Lactobacillus plantarum WCFS1, Lactobacillus helveticus CP53, Bifidobacterium lactis HN019, Bifidobacterium animalis DN-173010, Bifidobacteriun animalis Bb12, Bifidobacterium infantis 35624, Lactobacillus casei 431, Lactobacillus acidophilus NCFM, Lactobacillus reuteri ING1, Lactobacillus salivarius UCC118, Propionibacterium freudenreichii JS, Escherichia coli Nissle 1917.

It is to be understood that any of the above mentioned bacteria may be genetically modified bacteria or they may be food-grade bacteria commonly used in industrial processes.

According to a preferred embodiment of the invention the amount of bacterium is 10⁴ to 10¹¹ Colony forming units (Cfu) per gram of product. More preferably 10⁶ to 10⁸ cfu/g.

The skilled person will appreciate that the amount of bacterium depends on the type of bacterium used and the serving size of the composition.

Suitable compositions according to the invention are emulsions. Suitably emulsions have from 0.5 to 80 wt % of fat, more suitably from 10 to 60 wt % of fat, or even from 20 to 40 wt % of fat. Preferably the fat is vegetable fat. Preferably less than 80% of the fat is cocoa fat.

Preferably the composition is a food product, such as a spread, yoghurt, mayonnaise. Suitable food products are margarines, dairy spreads, creams, and yoghurt drinks.

In a preferred embodiment the emulsion of the present invention is fat-continuous.

Water activity (a_{w}) refers to the availability of water in a food or beverage and represents the amount of water that is available to support microbial growth. Pure water has an aw of 1.00. Water activity is defined as the ratio of vapor pressure of food to vapor pressure of pure water. It is different from water content.

In a preferred embodiment the composition according to the invention has a water activity a_{w} of at least 0.5.

The present invention is particularly suitable for compositions wherein the water activity a_{w} is at least 0.5. In contrast to the present invention, until now many measures for increasing the survival rate of bacteria are directed to decreasing the water activity of the composition by e.g. drying (spray- or freeze-drying) or freezing the composition or by encapsulation. Dry compositions usually have an aw of lower than 0.4 or even lower than 0.2. The present invention provides a solution for the survival of food grade bacteria for compositions with a high water activity such as for many food products. In a preferred embodiment the composition according to the present invention has a water activity a_{w} of at least 0.6, preferably between 0.7 and 0.95, more preferably between 30 0.8 and 0.9.

In addition, the present invention is suitable for products wherein the food grade bacteria do not need to be encapsulated. Encapsulation is often cumbersome and expensive. Therefore another embodiment of the present invention comprises food grade bacteria that are not encapsulated.

Preferably the composition of the present invention does not contain oatfibers.

Preferably the composition of the present invention does not contain live Saccharomyces species.

Preferably the composition of the present invention does not contain more than 40wt % of wheat flour.

The composition of the present invention may be produced in any known method.

A preferred embodiment encompasses a method for making a composition according to the present invention wherein the dry food grade bacterium is rehydrated in the presence of lecithin.

### EXAMPLES

### Measuring Viability of Probiotics in Spreads

Portions of 20 g of a spread were melted in 90 ml sterile peptone-physiological salt solution for 20 min at 39° C. Subsequently this mixture was shaken for 10 min. The water phase was diluted further in peptone-physiological salt solution in steps of 10-fold by mixing each time 1 ml of the concentrate into 9 ml of sterile peptone-physiological salt solution. Appropriate dilutions were pour plated using MRS as the cultivation agar for L. reuteri. Petri dishes were incubated for 2 days under anaerobic conditions at 37° C. and plates carrying 30-300 colonies were used for counting the actual number of colonies. The number of live cells per gram of product was calculated, taking into account the dilution steps that were applied, and expressed as the number of colony forming units per gram of product (Cfu/g).

### Example 1

### Lactobacillus reuteri in a Spread with Lecithin

Low fat (28%) spreads were prepared (table 1) using standard processing conditions. Freeze dried L. reuteri cells were hydrated and mixed into the product. Viability was assessed by plate counting and expressed as the % of the number of cells directly after production. Products were stored at 5° C. for 12 weeks and viability was checked every 3 weeks. The number of viable cells found over storage was significantly higher in spreads containing 0.1% lecithin when compared to spreads containing no lecithin (table 2).

TABLE 1
Ingredients for 28 wt % fat spread

| Lactobacillus Reuteri (ATCC 55730 or | |
|---|---|
| SD2112 or DSM17938) | 7 × 10⁷ CFU/g |
| hardstock fat interesterified mix of palm | 11.54 |
| oil and palm kernel oil | |
| sunflower oil | 15.93 |
| Monoglyceride | 0.42 |
| Polyglycerol polyricinoleate | 0.1 |
| Flavour | 0.06 |
| Beta carotene | 0.0008 |
| Vit A (1.7MIU) | 0.0017 |
| Vit. D3 (1.0MIU) | 0.0003 |
| Water | balance |
| Modified tapioca starch | 4.75 |
| Pig Skin Gelatine | 3 |
| Buttermilk Powder | 1 |
| Emulgold (ex Kerry) | 1 |
| Salt | 0.5 |
| Potassium sorbate | 0.13 |

TABLE 2
Survival of L. reuteri in 28% fat spread with or
without Lecithin over storage for 12 weeks at 5° C. Survival
is expressed as % of the start level.

Time (weeks)

| | 0 | 4 | 16 | 12 |
|---|---|---|---|---|
| NO Lecithin | 100 | 4.3 | 2.6 | 0.1 |
| 0.1% native sunflower Lecithin | 100 | 48.8 | 6.3 | 4.5 |

### Example 2

### Lactobacillus reuteri Hydrated in the Presence of Lecithin

Low fat (28%) spreads were prepared using a standard recipe (table 1) and standard processing conditions. Freeze dried L. reuteri cells were hydrated in the presence or absence of Lecithin and subsequently mixed into the product. Viability was assessed by plate counting and expressed as the % of the number of cells directly after production. Products were stored at 5° C. for 12 weeks and viability was checked every 3 weeks. The number of viable cells found in spreads over storage was higher when cells had been hydrated in the presence of lecithin (table 3).

TABLE 3
Survival of L. reuteri in 28% fat spread over
storage for 12 weeks at 5° C. Freeze dried L. reuteri was
hydrated with or without Lecithin before inclusion in the
spread. Survival is expressed as % of the amount dosed at
the start.

| | Time (weeks) | | | | |
|---|---|---|---|---|---|
| | 0 | 4 | 6 | 9 | 12 |
| no Lecithin in | 56.2 | 54.0 | 7.8 | 4.1 | 0.5 |
| hydration medium | | | | | |
| 1% Lecithin in | 38.5 | 53.0 | 14.8 | 5.0 | 0.7 |
| hydration medium | | | | | |

### Example 3:

### Lecithin Concentration

Low fat (28%) spreads were prepared using a standard recipe and standard processing conditions (Table 1). Different amounts (0-1.0%) of Lecithin were included in the products. Freeze dried L. reuteri cells were hydrated in the presence of Polysorbate 80 and subsequently mixed into the product. Viability was assessed by plate counting and expressed as the % of the number of cells directly after production. Products were stored at 5° C. for 6 weeks and viability was checked every 3 weeks. The number of viable cells found in spreads over storage was directly related to the Lecithin concentration with best survival found in spreads with the highest Lecithin concentration (1%) (table 4).

TABLE 4
Survival of L. reuteri in 28% fat spread over
storage for 6 weeks at 5° C. Spreads contained no, 0.1%,
0.5% or 1.0% native sunflower Lecithin. Survival is
expressed as % of the start level.

| | Time (weeks) | | |
|---|---|---|---|
| | 0 | 3 | 6 |
| 0% Lecithin | 100 | 4.4 | 3.2 |
| 0.1% Lecithin | 100 | 12.0 | 5.4 |
| 0.5% Lecithin | 100 | 26.4 | 8.5 |
| 1% Lecithin | 100 | 32.2 | 10.8 |

1. Composition comprising live food grade bacterium and lecithin wherein the water activity of the composition is at least 0.5 and the amount of fat is between 10 and 80 wt %.

2. Composition according to claim 1 wherein the food grade bacterium is a probiotic.

3. Composition according to claim 1 wherein the food grade bacterium is selected from the genera Lactobacillus, Bifidobacterium, and streptococcus.

4. Composition according to claim 1 wherein lecithin is present in an amount of from 0.01 to 10 wt %.

5. Composition according to claim 1 wherein the amount of bacterium is 104 to 1011 Colony forming units (Cfu) per gram of product.

6. Composition according to claim 1 wherein the composition is an emulsion.

7. Composition according to claim 6 wherein the emulsion is a fat-continuous emulsion.

8. Composition according to claim 1 wherein the composition is a food product.

9. Composition according to claim 8 wherein the food product is a spread, yoghurt, mayonnaise.

10. Composition according to claim 1 wherein the composition has a water activity a_{w} of at least 0.6.

11. Composition according to claim 1 wherein the food grade bacteria is not encapsulated.

12. Method for making a composition according to claim 1 wherein the food grade bacterium is rehydrated in the presence of lecithin.
